(19) United States
(12) Patent Application Publication
(10) Pub. No.: US 2009/0104518 A1
(43) Pub. Date: Apr. 23, 2009

(54) Battery module comprising an energy storing element whereof the contact is activated by mutual layer tightening

(76) Inventors: Luc Nedelec, L'hopital Comfrout (FR); Frederic Guiguen, St Evarzec (FR)

Correspondence Address: PAULEY PETERSEN & ERICKSON, 2800 WEST HIGGINS ROAD, SUITE 365, HOFFMAN ESTATES, IL, 60195, US

(21) Appl. No.: 11/664,927

(22) PCT Filed: Oct. 5, 2005
(86) PCT No.: PCT/EP05/55018

§ 371 Date: Dec. 18, 2008

(30) Foreign Application Priority Data
Oct. 6, 2004 (FR) 0410522

(51) Int. Cl. H01M 2/22; H01M 10/04

(52) U.S. Cl. 429/161; 29/623.1

(57) ABSTRACT

The invention concerns a battery module comprising at least one element consisting of stacked layers, some layers having edges extending beyond the edges of other layers, thus forming projecting parts, and a tightening member maintaining the projecting parts of the layers tightly close together. The invention is characterized in that the tightening member is a self-contained elastic member which by itself, without external aid, provides for the tightening of said projecting parts and its own grip thereon, and is adapted to provide an electrical connection of said layers to a circuit.

The present invention relates to the field of electric energy storage elements.

Still more specifically, the present invention in particular relates to multilayer electrochemical elements based on polymer materials comprising an electrolyte framed by two electrodes forming a cathode and an anode, respectively.

The invention is notably, but not exclusively, applied to devices comprising an anode based on lithium.

The present invention is applied to the making of capacitors, supercapacitors, and generators or batteries.

Examples of such electrochemical elements may be found in documents FR-A-2737339, FR-A-2759087, FR-A-2759211, FR-A-2808622.

Techniques for making electric energy storing elements as multilayer stacks or coils are known.

The wound type elements are generally made from a plurality of monolayer or multilayer films, either polymeric or not, assembled together and superimposed in order to form a complex. In the case of the making of elements by winding, the thereby obtained complex is wound on a circular mandrel of revolution or on a flat or quasi-flat mandrel. When the number of winding turns is sufficient, the layers should be cut by cutting means transversely. The obtained winding is then released from the mandrel.

A concern in the field of energy storing elements as windings or stacks is making electric connector technologies with which series/parallel connections may notably be achieved between these sets. Indeed, these connector technologies should allow connection to some thin layers of the winding or of the stack while preventing short circuits between the layers of the various films.

To facilitate the making of these connector technologies, a solution when making the winding or the stack consists of controlling the lateral positioning of the films relatively to each other. Thus, in the final element, certain layers will be positioned so that one of their edges “juts out” more or less relatively to the edges of the other layers.

With this technique, it is for example possible to deposit on the side faces of the element, a metal, this metal being exclusively positioned on the side edges of one or a plurality of layers. With the lateral shift between the layers, they may further be distinguished from each other according to their positioning when they are connected.

Document U.S. Pat. No. 5,415,954 published on May 16^{th} 1995 describes a lithium-polymer generator comprising an element formed with superimposed layers. In this element, the side edges of the lithium anode layers extend beyond the edges of the other layers. The output contact of the anode layers is made with an intermediate layer in a metal compatible with lithium, extending transversely to the edges of the anode layers and in contact with the latter.

Making an output contact is a particularly delicate operation because lithium is only compatible with a small number of metals (copper, nickel, steel), it further poorly lends itself to assembly by welding.

Document WO 13/094258 published on Nov. 13^{th} 2003 describes a current collecting terminal comprising two arms which will clasp the projecting parts of the layers of the elements in order to maintain them in contact with each other.

The terminal described in this document needs to be tightened by means of a tightening tool in order to be attached onto the projecting parts of the layers. If necessary, the terminal may further be welded or bonded on the projecting parts of the layers.

An object of the invention is to propose a technique for making a contact in a battery multilayer element in a simpler and more reliable way than with the techniques of the prior art.

For this purpose, the invention proposes a battery module comprising at least one element formed with superimposed layers, wound according to a flattened profile, some layers having edges which extend beyond the edges of the other layers, thus forming projecting parts. The module further includes a tightening member maintaining the projecting parts of the layers of at least one element, tightly close together.

The tightening member is a self-contained elastic member which by itself, without any external aid, provides for the tightening of said projecting parts and its own grip thereon, and is adapted to provide an electric connection of said layers to a circuit.

For this purpose, the tightening force of the elastic member is calculated in order to withstand expansion and contraction forces to which the element is subject at each operating cycle.

By “self-contained elastic member”, is meant within the scope of the invention, a member capable of being deformed in an open position in which the projecting parts of the layers may be introduced into the member, and capable, because of its elasticity, of spontaneously returning to a tightening position in which it maintains the projecting parts of the layers tightly close together.

With the invention, it is possible to maintain the layers in electrical contact with each other, without resorting to a tightening tool or to a weld.

This solution is particularly suitable in the case of lithium anode layers. Indeed, it was noticed that as lithium is ductile, it provides good connection between the layers by adhesion under the effect of the tightening member.

Advantageously, the tightening member is in metal. Thus, this member forms a conducting contact with which the layers which it supports may be electrically connected to an electrical circuit.

In an embodiment of the invention, the tightening member is formed with an elastic clamp having two jaws capable of clasping the projecting parts of the layers. In the case of lithium layers, as lithium is a ductile material, the layers conform to the shape of the member, providing good connection by adhesion.

The tightening member is an elastic member which provides tightening of the projecting parts under a constant force regardless of the manufacturing disparities of the elements.

The module may further have the following features:

the clamp is formed in a folded metal sheet in order to form tightening jaws,

the free ends of the jaws are folded back outwards according to a radius of curvature larger than 0.6 mm,

the free ends of the jaws are folded back at right angles and include longitudinal oblong apertures capable of receiving teeth of a placement tool,

the clamp has a maximum opening force of 160 N,

the tightening member (100, 120, 140, 160, 180, 200, 220) is in metal,

the tightening tool is connected to an electrically conducting element capable of electrically connecting the layers tightly maintained close together by the tightening member to a circuit,

the tightening member is adapted to provide for its own grip on the projecting parts of the layers and electric connection thereof for a period larger than the lifetime of the module,

the tightening tool exerts on the projecting parts of the layers a tightening force larger than 50 N,

the tightening tool comprises two jaws provided with grips capable of mechanically gripping the projecting parts of the layers,

the tightening member comprises two jaws having teeth,

the tightening member simultaneously maintains the layers of several elements tightly close together,

the tightening member is bimetal, formed with a sheet in a material with high elastic properties, such as cupronickel surrounding and integral with a sheet in a high electric conductivity material such as nickel silver,

a copper sheet is interposed between the tightening member and the projecting parts of layers,

the tightening member at a longitudinal end has longitudinal slots defining protective flanges without any tightening for the layers tightened by the tightening member,

the tightening member on an outer portion has an electrical insulator coating capable of preventing short circuits with an adjacent element,

the tightening member comprises an elastic clamp clasping the projecting parts of one or more anode layers,

the tightening member comprises an elastic clamp clasping the projecting parts of one or more collector layers,

the tightening member comprises a dual clamp clasping on one side the projecting parts of one or more anode layers of a first element and on the other side the projecting parts of one or more collector layers of a second element, both elements then being electrically connected in series,

the tightening member comprises a dual clamp clasping on each side the projecting parts of one or more anode layers of two neighboring elements in order to electrically connect them in parallel,

the tightening member comprises two clamps integral with each other, clasping the collectors of two elements in order to electrically connect these elements in parallel, respectively,

the tightening member is an elastic member which provides for the tightening of the projecting parts under a constant force regardless of the manufacturing disparities of the elements,

the tightening member has a contact angle on the projecting parts of the layers between 10° and 30°.

The invention also relates to a method for making an electric connection on a battery module comprising at least one element formed with superimposed layers, wound according to a flattened profile, certain layers having edges which extend beyond the edges of the other layers, thus forming projecting parts, said method comprising the placement of a tightening member maintaining the projecting parts of the layers tightly close together.

The tightening member appears as a self-contained elastic member adapted to provide by itself without any external aid, for the tightening of said projecting parts and its own grip thereon, and is adapted to provide an electrical connection of the layers to a circuit.

In an embodiment of this method, as the tightening member is formed with an elastic clamp having two jaws capable of clasping the projecting parts of the layers, the method comprises the steps:

moving the jaws apart of the elastic clamp by means of a tool formed with two elements, each element being able to be engaged in a hook or in apertures of one of the jaws,

and then introducing the projecting parts of the layers between the jaws,

releasing the jaws so that they will clasp the projecting parts.

In an application of this method, the tool includes a stop preventing the jaws of the clamp from being moved apart beyond the elastic limit of the material of which it consists.

Other features and advantages will further emerge from the description which follows, which is purely illustrative and non-limiting and should be read in regard to the appended figures wherefrom:

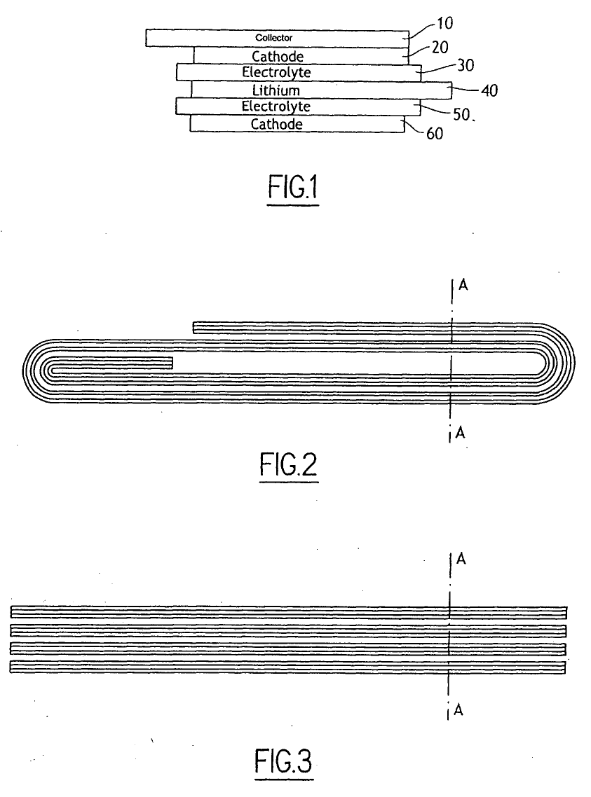

FIG. 1 schematically illustrates a transverse sectional view along AA of FIG. 2 or 3, of a complex film structure example of the sandwich type intended to form a battery element,

FIG. 2 schematically illustrates an element formed by winding,

FIG. 3 schematically illustrates an element formed by stacking,

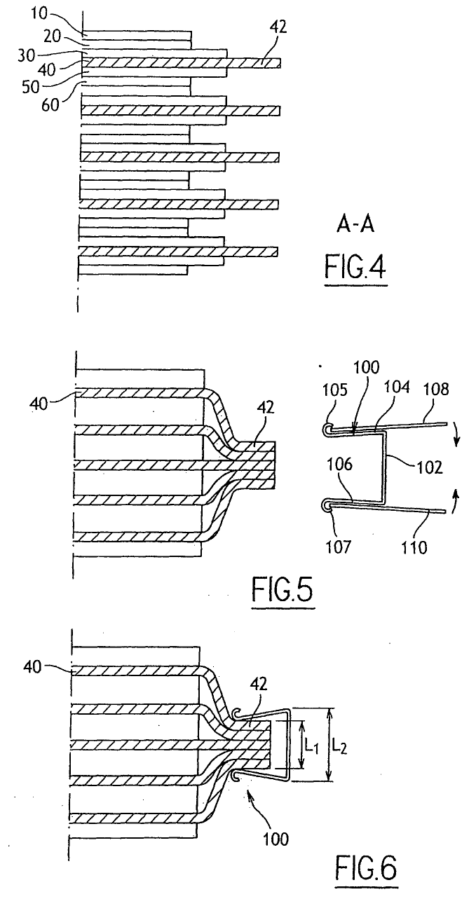

FIG. 4 schematically illustrates a transverse sectional view (according to the section line AA of FIG. 2 or of FIG. 3) of an element formed by winding or stacking,

FIG. 5 schematically illustrates a step for placing a member for tightening the anode layers of a battery element,

FIG. 6 schematically illustrates the battery element, the anode layers of which are held tightened against each other by tightening member,

FIGS. 7-10 schematically illustrate in a transverse section examples of tightening members which may be used within the scope of the invention,

FIG. 11 schematically illustrates anode layers maintained tightly close together by a tightening member, a metal foil being inserted between the member and the layers,

FIG. 12 schematically illustrates in a perspective view, an exemplary tightening member on which a connection conductor has been attached,

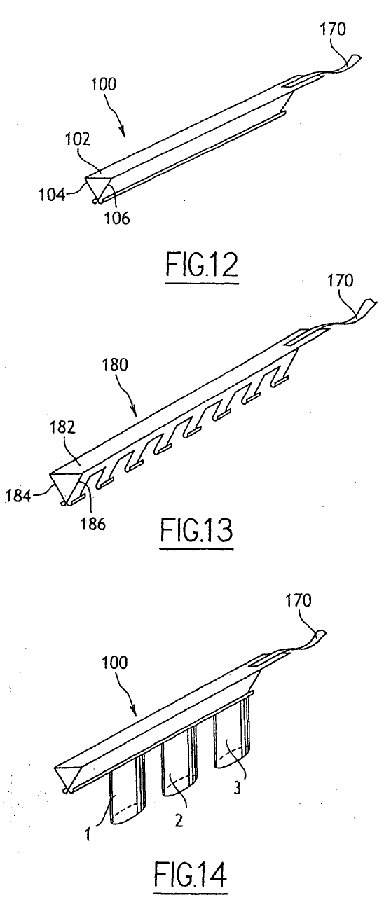

FIG. 13 schematically illustrates in a perspective view another exemplary tightening member having teeth,

FIG. 14 schematically illustrates in a perspective view a series of elements, electrically connected in parallel by a same tightening member,

FIG. 15 schematically illustrates a dual exemplary tightening member intended to make a connection between elements,

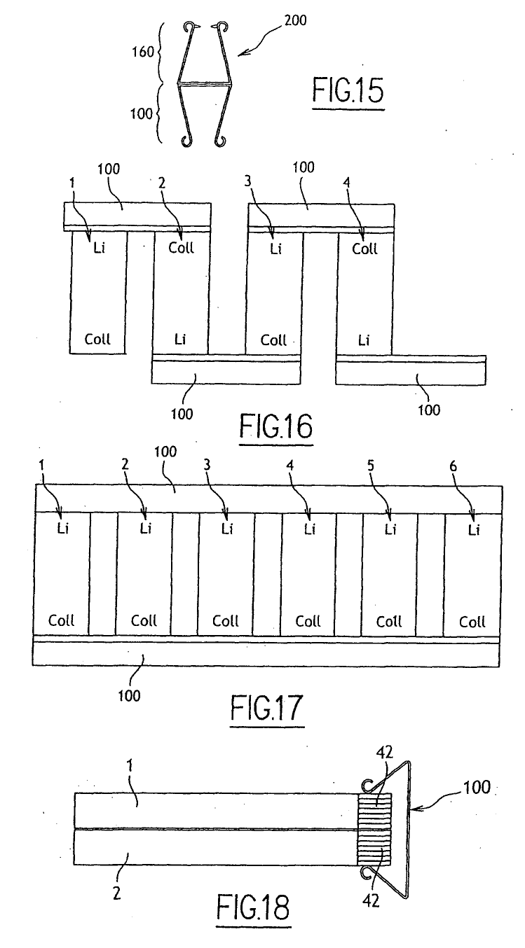

FIG. 16 schematically illustrates an exemplary assembly of battery elements, in which the elements are connected in series,

FIG. 17 schematically illustrates an exemplary assembly of battery elements, in which the elements are connected in parallel,

FIG. 18 schematically illustrates a sectional view of two battery elements connected in parallel by a same tightening element, as shown in FIG. 17,

FIGS. 19-21 illustrate exemplary assemblies of elements in a battery module,

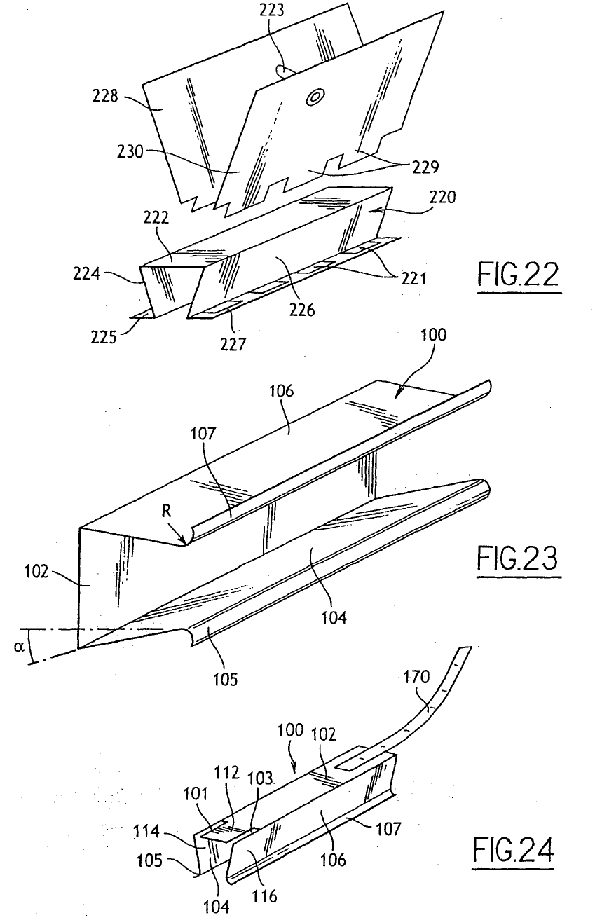

FIG. 22 schematically illustrates in a perspective view an exemplary tightening member in an alternative including oblong orifices suitable for their placement by a tool and the associated placement tool,

FIG. 23 schematically illustrates in a perspective view an exemplary tightening member,

FIG. 24 schematically illustrates in a perspective view an exemplary tightening member in an alternative including protective flanges.

FIG. 1 illustrates (in a cross-sectional view) a complex film structure of the sandwich type intended to form a battery element. The complex film comprises a collector layer 10 (for example, in aluminium or Becromal), a cathode layer 20 (for example, based on POE (polyoxyethylene) and on lithium salt), an electrolyte layer 30, an anode layer 40 (for example in lithium), an electrolyte layer 50 and a cathode layer 60. The layers of electrolytes 30 and 50 are for example based on LiV₃O₈ or V₂O₅ and POE. The aluminium collector 10 is preferably coated with an anticorrosive barrier, for example based on Ti nitride or another material, graphite for example. It will be noted that the edges of the electrolyte layers 50 and 30 are superimposed. Moreover, the anode layer 40 has an edge set back from the electrolytes 50 and 30 on the emerging side of the collector 10, while it juts out from the electrolytes 30, 50 on the opposite sides.

FIG. 2 schematically illustrates an element obtained by winding the complex film of FIG. 1 on a substantially flat mandrel (for the sake of simplification, the number of illustrated turns is less than the actual number).

FIG. 3 schematically illustrates an element obtained by stacking several complex films having a structure such as the one illustrated in FIG. 1 (for the sake of simplification, the number of stacked films is less than the actual number).

The elements of FIGS. 2 and 3 are intended to be integrated into a battery module.

FIG. 4 illustrates a cross-sectional view along the direction A-A of an element as illustrated in FIGS. 2 and 3. Such an element is formed with a superposition of several complex layers each comprising a collector layer 10, a cathode layer 20, an electrolyte layer 30, an anode layer 40, an electrolyte layer 50 and a cathode layer 60. The anode layers 40 (hatched) have edges which extend beyond the edges of the other layers, thus forming projecting parts 42. These projecting parts 42 are intended to receive connection means with which they may be electrically connected to a circuit.

FIG. 5 illustrates a step for placing a tightening member 100 intended to maintain the projecting parts 42 of the anode layers 40 tightly close together. In this figure, the member 100 is an elastic clamp.

Such a clamp is illustrated in FIG. 7, it is formed with a profile having a section with a general symmetrical trapezoidal shape. The profile is obtained from an elastic metal foil folded along two parallel axes. The clamp comprises a rear portion 102 extending between both folding axes and two side portions 104 and 106 located on either side of the rear portion 102. Both side portions 104 and 106 extend facing each other in order to form the two “jaws”. Both of these side portions 104 and 106 are not parallel but oriented so as to approach each other at their free edge. Each side portions 104, 106 has a hook 105, 107, formed by bending its free edge outwards.

As illustrated in FIG. 5, the hooks 102 and 107 are adapted to receive a tool with which both jaws 104 and 106 may be moved apart in order to introduce between them the projecting parts 42 of the anode layers 40. Such a tool comprises two elements 108 and 110. Each element 108, 110 has an end intended to be engaged into one of the hooks 105, 107, and a free end. When the free ends of both elements 108 and 110 are pressed towards each other, both elements will press on the folds of the clamp 100 and the jaws of the clamp 100 will move apart by a lever effect.

The projecting parts 42 of the anode layers are then easily introduced between the jaws 104 and 106. The jaws are then released and will clasp the projecting parts 42.

As illustrated in FIG. 6, once in place, because of its elasticity, the clamp 100 maintains the projecting parts 42 of the anode layers tightly close together. Preferably, as illustrated in this figure, the width L₂ of the rear portion of the clamp 100 is larger than the thickness L₁ of the whole of the anode layers 40 clasped by the clamp.

As it is understood in FIG. 6, the tightening member formed by the elastic clamp 100 is a self-contained member, i.e., it provides by itself, without any external aid, the tightening of the projecting parts 42 and its own grip thereon.

Further, this member is adapted to provide an electric connection of anode layers 40 to a circuit. Preferentially, the tightening member is adapted to provide its own grip and an electric connection for a period larger than the life-time of the battery module.

Preferably, the tightening member exerts a tightening force larger than 50 N on the projecting parts 42 of the layers 40. The tightening force of the elastic member is calculated in order to withstand the expansion and contraction forces to which the element is subject at each operating cycle on the one hand, and to allow the clamp to provide its grip on the stack for a period larger than the acceptable life-time of the battery module, and in order not to risk damaging the cathode material which it will tighten on the other hand.

Further, the clamp 100 has a maximum opening force of 160 N. With this feature, the elastic limit of the material forming the clamp cannot be exceeded, and consequently there is no risk of reducing its elastic tightening grip during operation of the battery.

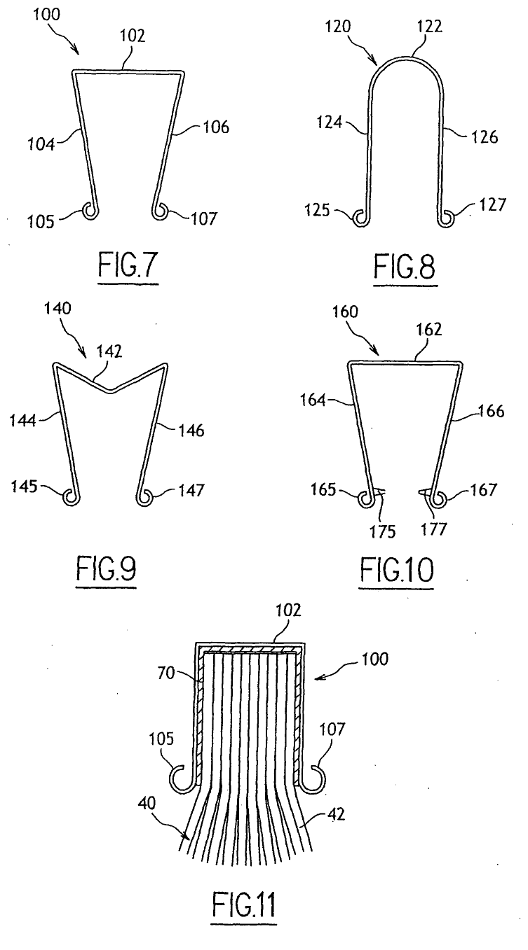

FIGS. 8, 9 and 10 illustrate alternatives of the clamp of FIG. 7. In FIG. 8, the clamp 120 has a general U-shaped section. It comprises a curved rear portion 122 from which extend two side portions 124 and 126 as well as two hooks 125 and 127.

In FIG. 9, the clamp 140 is similar to the one of FIG. 7 except that it has a rear portion 142 curved towards the inside of the clamp. This feature facilitates opening of the clamp by means of a tool.

In FIG. 10, the clamp 160 is similar to the one of FIG. 7, except that it has claws 175 and 177 positioned on each jaw of the clamp, facing each other and oriented towards the inside of the clamp. These claws 175 and 177 are preferably positioned close to the free edges of the side portions 164 and 165 in the area where the clamp will press on the anode layers. With these claws, the anode layers may be mechanically gripped, or even pierced through in order to better maintain them in place in the clamp and to further improve the quality of the connection of the clamp on the material of the anode during the life-time of the battery.

Preferentially, the clamp 100, 120, 140, or 160, is made in copper spring metal (for example, formed from a copper-beryllium alloy). The clamp then plays the role of a conducting contact with which the anode layers which it maintains tightly close together, may be electrically connected to an electric circuit.

However, as illustrated in FIG. 11, the clamp 100 which clasps the projecting parts 42 of the anode layers 40 may be made in spring steel metal or in another metal. In this configuration, the copper foil 70 was interposed between the clamp 100 and the anode layers. This copper foil improves electric conduction between the anode layers 40 and the clamp 100. Further, the copper foil 70 prevents any harmful chemical reaction between the anode layers 40 and the clamp 100. This feature is particularly useful in the case when the anode layers are in lithium, and the clamp is in a material chemically incompatible with lithium.

As an alternative, it is possible to make a bimetal clamp formed by a spring metal foil covered on its inner surface with a copper layer (or another metal compatible with the anode layers) in contact with the anode layers.

As an alternative, the clamp may be made in a cupronickel or nickel silver based material, which combines good elastic properties and good electric contact quality.

FIG. 22 schematically illustrates a clamp 220 and an associated placement tool formed with two elements 228, 230. The clamp 220 is formed with a profile obtained from a metal foil folded along two parallel axes. The clamp comprises a rear portion 222 extending between both folding axes and two side portions 224 and 226 located on either side of the rear portion 222. The free edges of the side portions 224 and 226 are folded back at right angles towards the outside of the clamp 220 so as to form two side tabs 225 and 227. The clamp thus has a section with the general shape of an Ω.

Both side tabs 225 and 227 include longitudinal oblong apertures 221 extending in a longitudinal direction of the profile. These apertures are intended to receive teeth 229 of the elements 228, 230 of the placement tool.

The teeth 229 of the elements are engaged into the apertures 221. When the free ends of both elements 228 and 230 are pressed towards each other, both elements will press on the folds of the clamp 220 and the jaws of the clamp 220 will move apart by a lever effect. A stop 223 positioned between the elements 228 and 230 prevents the jaws 224, 226 of the clamp 220 from moving apart beyond the elastic limit of the material of which it consists.

This system of side tabs with longitudinal apertures and of a tool with teeth allows both opening of the clamp and gripping or handling of the clamp by the tool.

FIG. 23 illustrates in a perspective view, the clamp 100 of FIG. 7. The radius R is the radius of curvature of the hooks 105 and 107 formed by bending outwards the free edges of the side portions 104 and 106. The radius of curvature R is preferably larger than 0.6 mm. Such a radius of curvature limits creep of the anode layers 40 clasped in the clamp 100. This radius of curvature R is provided regardless of the shape of the bending of the free ends of the jaws and of whether they have oblong apertures or not for engagement of the tool.

In this figure, angle α is the angle formed by a side portion 104 relatively to the longitudinal plane of symmetry of the clamp. This angle α is the contact angle of the clamp 100 on the anode layers; it defines the direction of the side portions 104 and 106 of the clamp 100 relatively to the clasped anode layers. The contact angle α is preferably between 10° and 30° in order to provide a good grip for the tightening of the clamp on the element and to prevent successive sliding movements of the clamp on the latter when the element is subject to swelling/retraction movements during its operating life.

FIG. 24 schematically illustrates a clamp 100 according to the clamp of FIG. 12, except that it comprises two longitudinal slots 101 and 103 made along the folding axes (or edges) of the clamp, at one of the ends of the clamp 100. Both slots 101 and 103 generate areas 112, 114 and 116 of a rear portion 102 and of side portions 104 and 106 disconnected from each other. The areas 112, 114 and 116 form protective flanges which do not tighten the projecting parts of the layers.

FIG. 12 illustrates in a perspective view the clamp 100 of FIG. 7. The connection of the clamp 100 to a circuit is performed by an electric conductor strip 170 (wire, braid, sheet, etc.) attached on the rear portion 102 of the clamp 100 (by means of welding, crimping, soft brazing, etc.).

FIG. 13 illustrates in a perspective view a clamp 180, for which the supporting generatrix on the anode layers is discontinuous. The side portions 184 and 186 of the clamp 180, forming the jaws, are cut out into slots in order to form teeth. This feature improves the hold of the anode layers in place in the clamp.

FIG. 14 schematically illustrates a clamp 100 used for connecting wound battery elements 1, 2, 3 with each other. Elements 1, 2 and 3 have their anode connected to a same terminal via the clamp 100 and the conductor 170.

Although described up to now for tightening stacks of lithium anode films, it is quite obvious that the clamps of the invention may also be used for tightening cathode collectors of the elements. With this particularity, it is possible to easily make series or parallel connections of the elements with each other, as this will be shown in the subsequent description.

FIG. 15 illustrates a dual clamp 200 consisting of two elementary clamps connected by their rear portion. The dual clamp 200 is formed with a simple trapezoidal clamp 100 of the type illustrated in FIG. 7 and with a trapezoidal clamp with claws 160 of the type illustrated in FIG. 10. The trapezoidal clamp 100 is more particularly suitable for tightening lithium anode layers whereas the clamp with claws 160 is more particularly suitable for tightening collector layers in Becromal. Both of these elementary clamps 100 and 160 are held together by welding or crimping. The thereby formed dual clamp 200 provides the electric connection of one or more anode layers of a battery element to one or more collector layers of another battery element, so that these battery elements may be mounted in series.

Other types of dual clamps may be contemplated. A dual clamp clasping on one side the projecting parts of one or more anode layers and on the other side the projecting parts of one or more cathode layers may be made. It is also possible to make a dual clamp clasping on each side the projecting parts of one or more anode layers, or even two clamps integral with each other clasping both cathodes respectively.

FIG. 16 illustrates an exemplary plane assembly of battery elements 1, 2, 3, 4 in series. In this assembly, the elements are positioned head-to-tail and flat beside each other, parallel with each other, their sides from which the lithium anode and collector layers jut out, being alternately oriented in one direction and in the other. The anode of one element is electrically connected to the collector of the following element via a clamp 100.

FIG. 17 illustrates a plane assembly example of battery elements 1, 2, 3, 4, 5, 6 in parallel. In this assembly, the elements are positioned flat, beside each other, parallel with each other, their sides from which the collector and anode layers jut out being oriented in the same direction. The anodes of the battery elements are electrically connected with each other via a same clamp 100. Also, the collectors of the battery elements are electrically connected with each other via another clamp 100.

As illustrated in FIG. 18, two or more elements 1 and 2 may be superimposed and connected through a same clamp 100, with which both elements may be connected in parallel if both elements are positioned in the same direction (collector on the same side), or they may be connected in parallel if the elements are positioned side-by-side head-to-tail.

FIG. 19 schematically illustrates an assembly example wherein a dual clamp 220 of the type of the one illustrated in FIG. 15 electrically connects a set of elements 1, 2, 3, 4, 5 and 6 positioned flat, through their collectors.

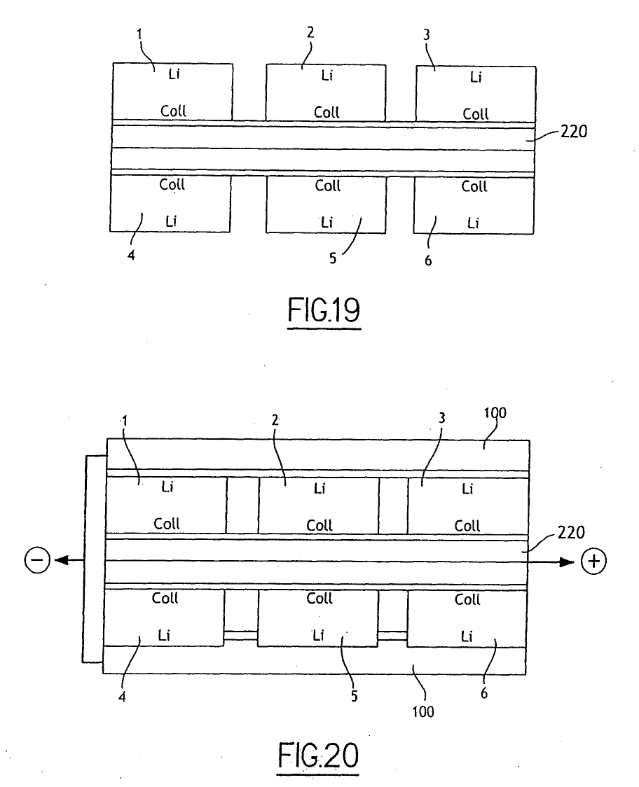

FIG. 20 schematically illustrates an exemplary assembly in parallel. In this assembly, a dual clamp 220 of the type illustrated in FIG. 15 electrically connects a set of battery elements 1, 2, 3, 4, 5 and 6 positioned flat, through their collectors, as in FIG. 19. Further, simple clamps 100 of the type illustrated in FIG. 7, electrically connect the elements 1, 2, 3 and 4, 5, 6 through their anodes. The clamp 220 is electrically connected to the plus (+) terminal of the battery whereas the clamps 100 are electrically connected to the minus (−) terminal of the battery.

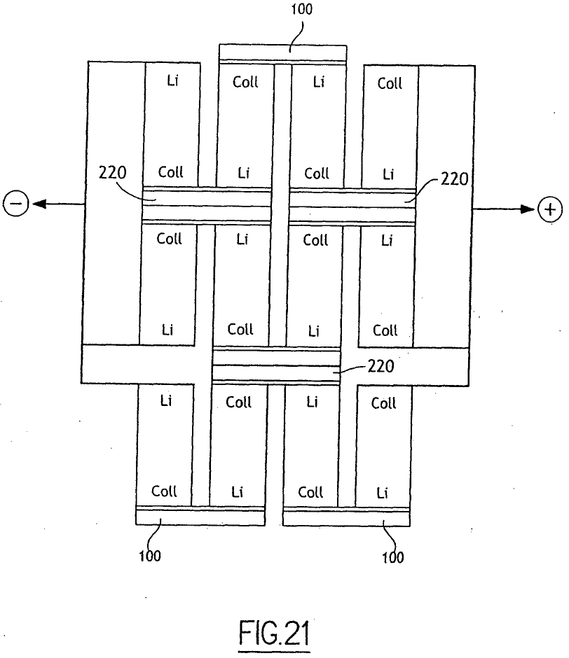

FIG. 21 schematically illustrates an exemplary mixed series-parallel plane assembly forming a battery module. In this assembly, with the clamps 100 and 220, it is possible to make planar battery stages, the power and the output voltage of which may be adapted for identical congestion of the planar stage, regardless of the power and voltage selected for the stage.

Further, the clamps 100 and 220 have the complementary advantage of stiffening the assembly which may then be easily handled during its mounting in a battery.

1. A battery module comprising at least one element (1, 2, 3, 4) formed with superimposed layers (10, 20, 30, 40, 50, 60) wound according to a flattened profile, some layers (10, 40) having edges extending beyond the edges of the other layers (20, 30, 50, 60), thus forming projecting parts (12; 42), and a tightening member (100, 120, 140, 160, 180, 200, 220) maintaining the projecting parts (12; 42) of some layers (10; 40) tightly close together, characterized in that the tightening member is a self-contained elastic member which by itself without any external aid, provides for the tightening of said projecting parts (12; 42), and its own grip thereon, and is adapted to provide an electrical connection of said layers (10; 40) to a circuit.

2. The module according to claim 1, characterized in that the tightening member (100, 120, 140, 1601, 180, 200, 220) is formed with an elastic clamp having two jaws capable of clasping the projecting parts (12; 42) of the layers (10; 40).

3. The module according to claim 2, characterized in that the clamp is formed in a folded metal foil in order to form tightening jaws.

4. The module according to claim 3, characterized in that the free ends of the jaws are folded back outwards along a radius of curvature larger than 0.6 mm.

5. The module according to claim 2, characterized in that the free ends of the jaws are folded at right angles and include longitudinal oblong apertures (221) capable of receiving the teeth (229) of a placement tool (228, 230).

6. The module according to claim 2, characterized in that the clamp has a maximum opening force of 160 N.

7. The module according to claim 1, characterized in that the tightening member (100, 120, 140, 160, 180, 200, 220) is in metal.

8. The module according to claim 7, characterized in that the tightening member is connected to an electric conductor element (170) capable of electrically connecting the layers (10; 40) maintained tightly close together by the tightening member (100, 120, 140, 160, 180, 200, 220) to a circuit.

9. The module according to claim 1, characterized in that the tightening member is adapted to provide for its own grip on the projecting parts (12; 42) of the layers (10; 40) and electric connection of the latter for a period larger than the life-time of the module.

10. The module according to claim 1, characterized in that the tightening member (100, 120, 140, 160, 180, 200, 220) exerts a tightening force larger than 50 N on the projecting parts (12; 42) of the layers (10; 40).

11. The module according to claim 1, characterized in that the tightening member (160) comprises two jaws provided with claws (175, 177) capable of mechanically gripping the projecting parts (12; 42) of the layers (10; 40).

12. The module according to claim 1, characterized in that the tightening member (180) comprises two jaws having teeth.

13. The module according to claim 1, characterized in that the tightening member (100, 120, 140, 160, 180, 200, 220) simultaneously maintains the layers of several elements tightly close together.

14. The module according to claim 1, characterized in that the tightening member (100, 120, 140, 160, 180, 200, 220) is bimetal, consisting of a foil in a material with high elastic properties, such as a cupronickel, surrounding and integral with a foil in a material of high electric conductivity, such as nickel silver.

15. The module according to claim 1, characterized in that a copper foil (70) is interposed between the tightening member (100, 120, 140, 160, 180, 200, 220) and the projecting parts (12; 42) of the layers (10; 40).

16. The module according to claim 1, characterized in that the tightening member (100) has at a longitudinal end, longitudinal slots (101, 103) defining protective flanges (112, 114, 116) without any tightening for the layers tightened by the tightening member.

17. The module according to claim 1, characterized in that the tightening member has on an external portion (102, 104, 106) an electric insulator coating capable of preventing short circuits with an adjacent element.

18. The module according to claim 1, characterized in that the tightening member (100, 120, 140, 160, 180, 200, 220) comprises an elastic clamp clasping the projecting parts of one or more anode layers.

19. The module according to claim 1, characterized in that the tightening member (100, 120, 140, 160, 180, 200, 220) comprises an elastic clamp clasping the projecting parts of one or more collector (10) layers.

20. The module according to claim 1, characterized in that the tightening member (100, 120, 140, 160, 180, 200, 220) comprises a dual clamp clasping on one side projecting parts of one or more anode layers of a first element and on the other side projecting parts of one or more collector (10) layers of a second element, both elements being then electrically connected in series.

21. The module according to claim 1, characterized in that the tightening member (100, 120, 140, 160, 180, 200, 220) comprises a dual clamp clasping on each side projecting parts of one or more anode layers of two neighboring elements in order to electrically connect them in parallel.

22. The module according to claim 1, characterized in that the tightening member (100, 120, 140, 160, 180, 200, 220) comprises two clamps integral with each other respectively clasping collectors of two elements in order to electrically connect these elements in parallel.

23. The module according to claim 1, characterized in that the tightening member is an elastic member which provides for tightening of the projecting parts (12; 42) under a constant force regardless of the manufacturing disparities of the elements.

24. The module according to claim 1, characterized in that the tightening member has a contact angle on the projecting parts (12; 42) of the layers (10; 40) between 10° and 30°.

25. A method for making an electric connection on a battery module comprising at least one element (1, 2, 3, 4) formed with superimposed layers (10, 20, 30, 40, 50, 60) wound according to a flattened profile, some layers (10, 40) having edges which extend beyond edges of other layers (20, 30, 50, 60) thus forming projecting parts (12; 42), said method comprising placement of a tightening member (100, 120, 140, 160, 180, 200, 220) maintaining the projecting parts (12; 42) of some layers (10; 40) tightly close together, said tightening member appearing as a self-contained elastic member adapted to provide for, by itself, without any external aid, the tightening of said projecting parts and its own grip thereon, and is adapted to provide an electrical connection of the layers to a circuit.

26. The method according to claim 25, characterized in that the tightening member (100, 120, 140, 160, 180, 200, 220) being formed with an elastic clamp having two jaws capable of clasping the projecting parts (12; 42) of the layers (10; 40), said method comprising the steps:
moving the jaws apart of the elastic clamp by means of a tool formed with two elements (108, 110) each element (108, 110) being capable of being engaged in a hook (125, 127) or apertures (221) of one of the jaws (104, 106; 124, 126; 144, 146; 164, 166; 224, 226),
and then introducing the projecting parts (12; 42) of the layers (10; 40) between the jaws (104, 106; 124, 126; 144, 146; 164, 166; 224, 226),
releasing the jaws (104, 106; 124, 126; 144, 146; 164, 166; 224, 226) so that they will clasp the projecting parts (12; 42).

27. The method according to claim 26, characterized in that the tool includes a stop (223) preventing the jaws of clamp from moving apart beyond an elastic limit of the material of which it consists.
